(19) United States
(12) Patent Application Publication
(10) Pub. No.: US 2015/0145655 A1
(43) Pub. Date: May 28, 2015

(54) Dynamic Proximity Control System

(71) Applicant: Seed Labs Sp. z o.o., Krakow (PL)

(72) Inventor: Szymon Slupik, Krakow (PL)

(21) Appl. No.: 14/612,922

(22) Filed: Feb. 3, 2015

Related U.S. Application Data
(63) Continuation of application No. 13/770,077, filed on Feb. 19, 2013.

(51) Int. Cl. G08C 17/02

(52) U.S. Cl. CPC G08C 17/02; G08C 2201/42; G08C 2201/93
USPC 340/12.5

(57) ABSTRACT

An illustrative dynamic proximity control system uses proximity to a mobile user's mobile station as a proxy for predicting which of several remote-controlled targets the mobile user wishes to remote-control via the mobile station or via a centralized controller in communication with the mobile station. The system dynamically sorts, filters, and arranges how the mobile user perceives the remote-controlled targets. The system and method enhance the mobile user's immediate access to targets that are close by, e.g., within the same room as the mobile user, by dynamically tailoring the choices provided to the user on the mobile station's display. Thus, the mobile user is presented with nearby choices that are likely candidates for remote control. Remote targets are filtered out. The system optionally includes location-beacon devices associated with each of the remote-controlled targets. Beacon signals received from the location-beacon devices enable the illustrative system to estimate the location of a respective target and, based on the location estimate, to tailor the choices of remote-controlled targets that are presented to the mobile user in a user interface on the mobile station's display, and to dynamically update the user interface and remotely control the targets based on proximity changes.

### FIELD OF THE INVENTION

The present invention relates to telecommunications in general, and, more particularly, to wireless telecommunications.

### BACKGROUND OF THE INVENTION

FIG. 1 depicts a schematic diagram of a portion of a typical remote control system 100 according to the prior art. FIG. 1 depicts: building 110, which comprises rooms 1, 2, and 3; room 1 comprises three remote-controlled targets: window shade 111, lamp 112, and audio-visual equipment 113; room 2 comprises four remote-controlled targets: appliance 121, wall switch 122, ceiling light 123, and thermostat 124; room 2 also comprises remote-control unit 101; room 3 comprises three remote-controlled targets: window shade 131, plug-in dimmer switch 132, and ceiling light 133. The targets 111-133 are well known in the art.

Remote control system 100 comprises remote control unit 101 and a plurality of remote-control receivers (not shown) each of which is associated with a respective one of the recited targets. Remote control system 100 is well known in the art. The remote-control receiver associated with a target is typically physically and electrically connected to its respective target, such as via the power plug of an appliance, or via an electrical connection (wired or wireless) as between the receiver and the target. The remote-control receiver receives commands from remote-control unit 101 and acts on the command by controlling an operation on the respective target such as dimming lights, powering on, powering off, activating a feature on the target, etc., according to the feature set and capabilities of remote control system 100.

Remote control unit 101 presents a control interface to the user such as buttons or, as illustrated here, a built-in interactive display 102. Display 102 provides the user with a list of all the targets under the control of remote control system 100, illustratively targets 111-133 and any other targets available in building 110 that are not shown here. When the user wishes to remote-control a particular target, the user searches for a target identifier on the list, selects the target, and actuates the desired remote-control operation that is available, such as power-on.

An advantage of this kind of prior-art system 100 is that is presents the user with the entire panoply of choices under remote control. However, a drawback of this approach is that it becomes unmanageable when the number of targets significantly exceeds the presentation capacity of the control interface such as display 102. In a large facility, such as a large house, office building, factory, or warehouse, where the user wishes to remote-control dozens and maybe hundreds of targets, finding the desired target can become difficult and cumbersome as the user attempts to navigate a very long list of targets. Moreover, in a sufficiently large facility, some targets may be out of range to the current location of remote-control unit 101, and even if the user could find the proper target by navigating the list, the remote-control operation would fail for being out of range. A different approach is needed.

### SUMMARY OF THE INVENTION

The present inventor devised a dynamic proximity control system that overcomes the disadvantages of the prior art, by using proximity to a mobile user's mobile station as a proxy for predicting which of several remote-controlled targets the mobile user wishes to remote-control via the mobile station or via a centralized controller in communication with the mobile station. The illustrative dynamic proximity control system dynamically sorts, filters, and arranges how the mobile user perceives the available choices of remote-controlled targets. The system enhances the mobile user's immediate access to targets that are near, by tailoring the choices provided to the user on the mobile station's display, and by dynamically updating the display when relevant changes in proximity occur as the mobile station moves around. Thus, the mobile user is presented with nearby choices, e.g., within the same room or within a predefined proximity distance, that are likely candidates for remote control while more distant targets are filtered out.

The illustrative system optionally includes location-beacon devices that are affixed to or installed proximate to or built into each remote-controlled target. Beacon signals received from a location-beacon device enable the illustrative system to estimate the location of the respective associated target and, based on the location estimate, to tailor the choices of remote-controlled targets that are presented to the mobile user as the mobile station moves around. The proximity changes are managed via an illustrative “proximity list” maintained by the mobile station (see, e.g., paragraphs [0088]-[0092]). Optionally, predefined remote-control commands are automatically and dynamically triggered based on changes in the composition of the proximity list and without interaction from the mobile user.

An optional controller in the dynamic proximity control system further enhances the user experience by performing some centralized functions. For example, upon receiving a signal from the mobile station that indicates what room the mobile station currently occupies, the controller powers on a light fixture in the room. Remote-control of the targets is performed by the illustrative mobile station, and/or by the controller, and/or by a collaboration between mobile station and controller.

An illustrative method that is associated with a system comprises:
receiving, by a mobile station, a beacon signal from each of a plurality of location-beacon devices, wherein each location-beacon device is associated with a respective remote-controlled target;
estimating, by the system, a distance between the mobile station and each location-beacon device;
generating, by the system, a proximity list based on the estimated distance between the mobile station and each location-beacon device; and
dynamically updating, by the mobile station, based on a change in the composition of the proximity list, a displayed user interface that comprises the identity of a first remote-controlled target that is associated with the changed composition of the proximity list.

An illustrative system is configured to:
(i) receive a beacon signal from each of a plurality of location-beacon devices, wherein each location-beacon device is associated with a respective remote-controlled target, and
(ii) estimate a distance between a mobile station and each location-beacon device, and
(iii) generate a proximity list based on the estimated distance between the mobile station and each location-beacon device, and
(iv) dynamically update, based on a change in the composition of the proximity list, a displayed user interface that comprises the identity of a first remote-controlled target that is associated with the changed composition of the proximity list.

An illustrative system comprises:

a plurality of location-beacon devices, wherein each location-beacon device is associated with a respective remote-controlled target; and

a mobile station that is configured to:
(i) receive a beacon signal from each of the plurality of location-beacon devices, and
(ii) generate a proximity list that is based on an estimated distance between the mobile station and each location-beacon device, and
(iii) based on a change in the composition of the proximity list, (A) dynamically update a displayed user interface that comprises the identity of a first remote-controlled target that is associated with the changed composition of the proximity list, and (B) optionally remotely control the first remote-controlled target.

### BRIEF DESCRIPTION OF THE DRAWINGS

FIG. 1 depicts a schematic diagram of a portion of a typical remote control system 100 according to the prior art.

FIG. 2A depicts a schematic diagram of a portion of dynamic proximity control system 200 according to an illustrative embodiment of the present invention, including illustrative location-beacon devices 203-i that are associated with remote-controlled targets, T-i; mobile station 201 is depicted located in room 2.

FIG. 2B depicts mobile station 201 located in room 1 and operating in accordance with the illustrative embodiment.

FIG. 2C depicts mobile station 201 telecommunicating with controller 250 in accordance with the illustrative embodiment.

FIG. 3 depicts an illustrative hardware platform for a location-beacon device 203-i according to the illustrative embodiment.

FIG. 4A depicts an illustrative hardware platform for a mobile station 201 according to the illustrative embodiment.

FIG. 4B depicts an illustrative user interface 412 for mobile station 201 according to the illustrative embodiment.

FIG. 4C depicts an illustrative user interface 422 for mobile station 201 according to the illustrative embodiment.

FIG. 5 depicts some salient operations of method 500 according to an illustrative embodiment of the present invention.

FIG. 6 depicts some salient sub-operations of operation 501 according to the illustrative embodiment.

FIG. 7 depicts some salient sub-operations of operation 511 according to the illustrative embodiment.

FIG. 8 depicts some salient sub-operations of operation 705 according to the illustrative embodiment.

FIG. 9 depicts some salient sub-operations of operation 513 according to the illustrative embodiment.

### DETAILED DESCRIPTION

To facilitate explanation and understanding of the present invention, the following description sets forth several details. However, it will be clear to those having ordinary skill in the art, after reading the present disclosure, that the present invention may be practiced without these specific details, or with an equivalent solution or configuration. Furthermore, some structures, devices, and operations that are well-known in the art are depicted in block diagram form in the accompanying figures in order to keep salient aspects of the present invention from being unnecessarily obscured.

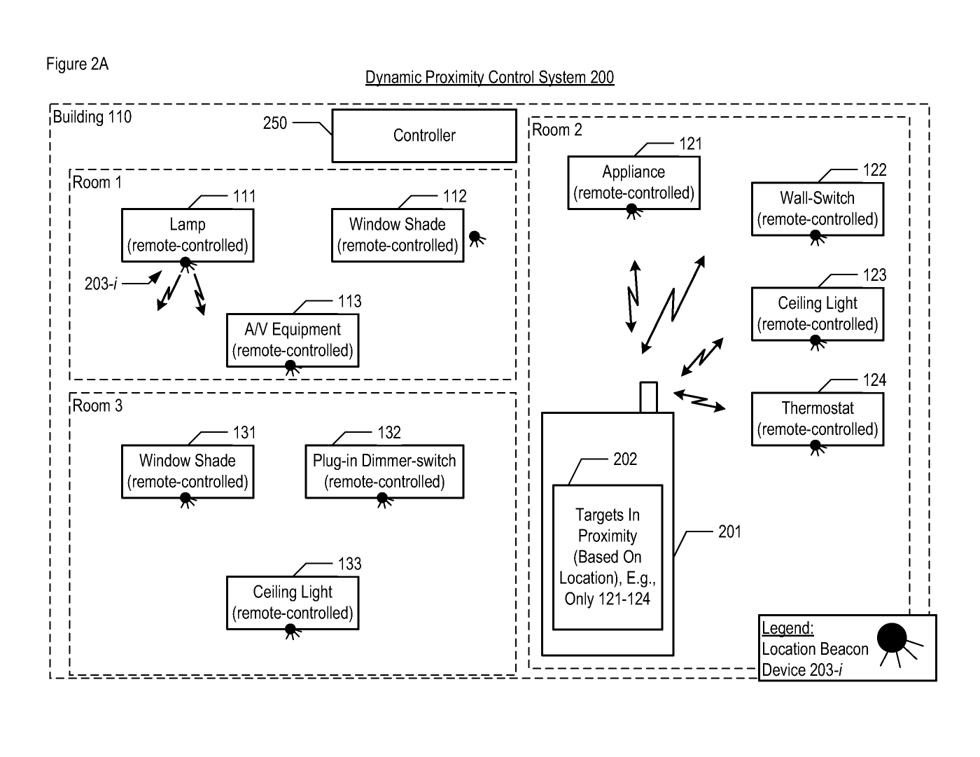

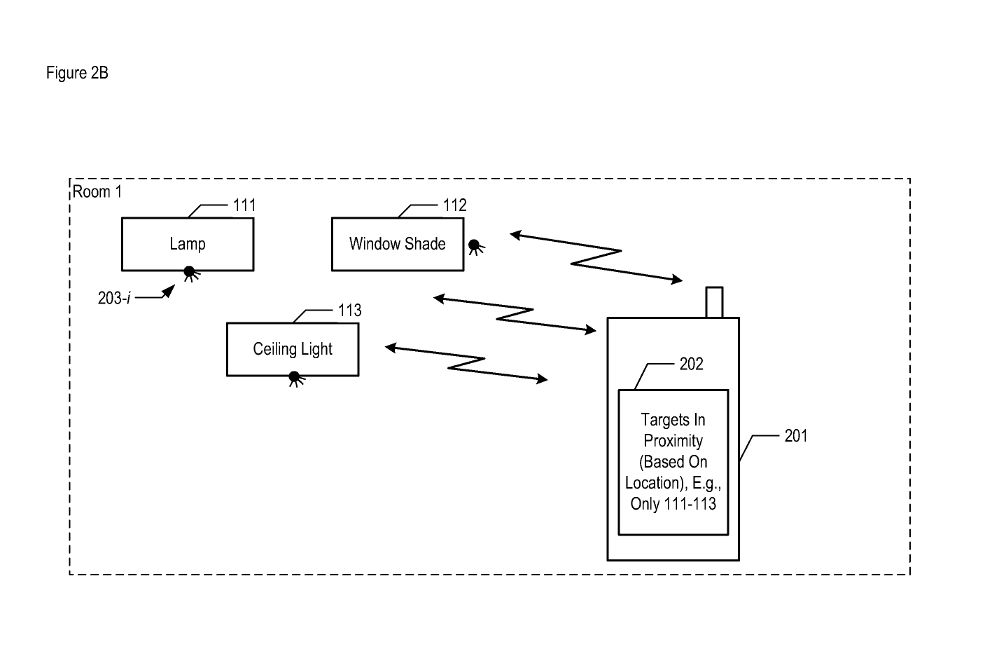

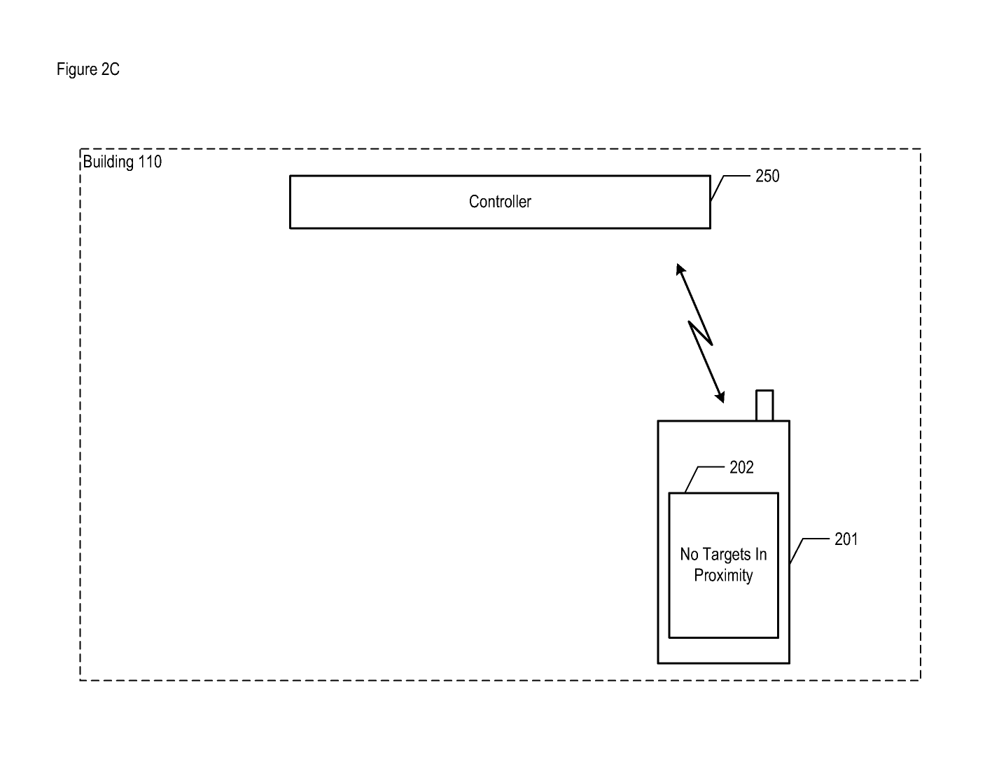

FIG. 2A depicts a schematic diagram of a portion of dynamic proximity control system 200 according to an illustrative embodiment of the present invention, including illustrative location-beacon devices 203-i that are each associated with a remote-controlled target, T-i. FIG. 2A depicts: building 110, which comprises rooms 1, 2, and 3, and controller 250; room 1 comprises three remote-controlled targets: window shade 111, lamp 112, and audio-visual equipment 113; room 2 comprises four remote-controlled targets: appliance 121, wall switch 122, ceiling light 123, and thermostat 124; room 2 also comprises mobile station 201; room 3 comprises three remote-controlled targets: window shade 131, plug-in dimmer switch 132, and ceiling light 133. The targets by themselves (i.e., lamp, window shade, coffee machine, thermostat, etc.) are well known in the art.

The illustrative dynamic proximity control system 200 comprises: mobile station 201, controller 250, a plurality of location-beacon devices 203-i each of which is associated with one of the recited targets, and a plurality of remote-control receivers (not shown) each of which is associated with one of the recited targets.

The remote-control receiver (not shown) associated with a target is physically and electrically connected to its respective target as appropriate to the installation, such as via the power plug of an appliance, or via an electrical connection (wired or wireless) as between the receiver and the target such as a ceiling light. The remote-control receiver receives commands from mobile station 201 and optionally from controller 250 and acts on the command by controlling an operation on the respective target such as dimming lights, powering on, powering off, activating a feature on the target, etc., according to the feature set and capabilities of system 200. Remote-control receiver technology is well known in the art, and according to the illustrative embodiment, mobile station 201 and controller 250 are capable of transmitting commands to the remote-control receivers here (not shown) in a manner that is compatible with prior-art remote-control receiver technology. Because each illustrative target depicted herein 111-133 is remote-controllable via its associated remote-control receiver (not shown), such targets are referred to herein as “remote-controlled targets” or simply “targets” for the sake of simplicity.

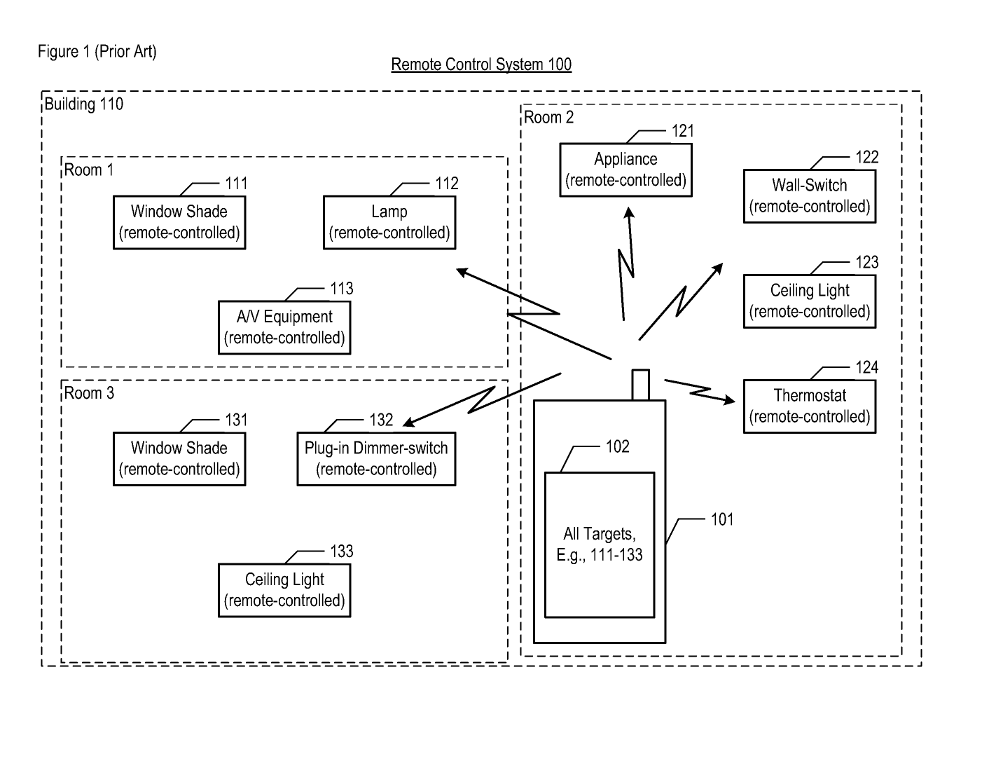

Mobile station 201 is the entity that coordinates and executes method 500 according to the illustrative embodiment. Mobile station 201 comprises a built-in display 202 that displays the remote-controlled targets that are in relevant proximity to mobile station 201 according to the illustrative embodiment. In FIG. 2A, only remote-controlled targets 121-124 are in relevant proximity to mobile station 201 according to the illustrative embodiment, and therefore only the identifiers of targets 121-124 are displayed to the user on mobile station 201. This approach is in notable contrast to the prior art as depicted in FIG. 1, where remote-control unit 101 presented every target in the system. Here, on the other hand, the illustrative dynamic proximity control system 200 is capable of proximity discrimination and dynamic updating of the user interface presented to the user, such that only the targets in relevant proximity are presented. Mobile station 201, its user interface and associated methods are described in further detail below and in the accompanying figures.

Location-beacon devices 203-i are each depicted here in association with a corresponding remote-controlled target, T-i. Each remote-controlled target, T-i, (e.g., targets 111-133) is associated with a corresponding location-beacon device 203-i. The location-beacon device 203-i is physically affixed to or arranged proximate (but not affixed) to the remote-controlled target, T-i, that it is associated with. For example, location-beacon device 203-112 that is associated with window shade 112 is proximate to the window shade, arranged on the nearby wall. For example, location-beacon device 203-113 is associated with audio-visual equipment 113 and is affixed thereto. In some embodiments, the location-beacon device 203-i is built into the remote-controlled target, T-i, such as, for example, being built into a lamp or light bulb, etc. It will be clear to those having ordinary skill in the art, after reading the present disclosure, how to arrange and affix a location-beacon device 203 with respect to its associated target in order to properly benefit from the functionality of dynamic proximity control system 200. Affixing and arranging technologies, e.g., glue, etc. are well known in the art and are left to the choice of the implementers practicing the present invention.

A location-beacon device 203-i broadcasts a beacon signal. Based on the received beacon signals, mobile station 201 performs its proximity discrimination functions and dynamically updates the user interface presented to the user. Location-beacon device 203-i is described in more detail below and in the accompanying figures.

Controller 250 is an optional component of dynamic proximity control system 200. Controller 250 is a centralized control unit that telecommunicates to and from mobile station 201. Controller 250 also is configured to transmit remote-control commands to the remote-controlled targets T-i. Controller 250 is described in more detail below and in the accompanying figures.

It will be further clear to those skilled in the art, after reading the present disclosure, how to make and use alternative embodiments wherein mobile station 201 supports and/or operates with any number of remote-controlled targets T-i, any number of location-beacon devices 203-i, and/or any number of controllers 250, or any combination thereof. In the illustrative embodiment, mobile station 201 operates with only one type of remote-control technology for remote-controlling the targets T-i, but it will be clear to those having ordinary skill in the art, after reading the present disclosure, how to make and use alternative embodiments with a plurality of different remote-control technologies such that some remote-controlled targets T-i operate under the control of one type of remote-control technology, while other remote-controlled targets operate under the control of a different type of remote-control technology, e.g., RF and infrared, without limitation. Likewise, it will be clear to those having ordinary skill in the art, after reading the present disclosure, how to make and use alternative embodiments with a plurality of different location-beacon devices technologies, e.g., different RF frequencies, different timing, different protocols, etc., without limitation.

FIG. 2B depicts mobile station 201 located in room 1 and operating in accordance with the illustrative embodiment. In contrast to FIG. 2A showing mobile station located in room 2, the present figure depicts mobile station 201 currently occupying room 1. Consequently, mobile station 201 presents to the user only those target identifiers that are in relevant proximity. Here, the targets that are in relevant proximity are lamp 111, window shade 112, and ceiling light 113. The other remote-controlled targets supported by system 200 are operational, but are not considered by the system to be in proximity of mobile station 201 according to the illustrative embodiment.

FIG. 2C depicts mobile station 201 telecommunicating with controller 250 in accordance with the illustrative embodiment. Controller 250 is a centralized control unit that telecommunicates to and from mobile station 201, and also is configured to remote-control at least some of the remote-controlled targets. According to the illustrative embodiment, controller 250 receives from mobile station 201 one or more of: the estimated current location of mobile station 201, the estimated geographic area (e.g., room 1, hallway, basement, etc.) that mobile station 201 currently occupies, and the proximity list (and/or an indication of its composition). According to the illustrative embodiment, controller 250 transmits to mobile station 201 one or more of: instructions or commands directed at certain remote-controlled targets such that mobile station 201 is to perform the remote-controlling of the respective target according to the instructions/commands received from controller 250. According to the illustrative embodiment, controller 250 also transmits remote control commands directly to one or more of the remote-controlled targets, based at least in part on information received by controller 250 from mobile station 201, e.g., composition of the proximity list, geographic area that mobile station 201 currently occupies, etc. Thus, controller 250 telecommunicates bi-directionally with mobile station 201, and is capable of both acting directly on received information (e.g., remote-controlling one or more targets), and acting indirectly by instructing mobile station to take action(s). The communication path between controller 250 and mobile station 201 is illustratively a direct wireless connection, but the invention is not so limited; in some embodiments the communication path between controller 250 and mobile station 201 is via a telecommunications network (whether a local-area network, a wide-area network, a public-switched network, the Internet, etc.—the present invention does not require a particular technology for instantiating the communications path between controller 250 and mobile station 201).

As noted earlier, according to the illustrative embodiment, mobile station 201 presents to the user only those target identifiers that are in relevant proximity. Here, there are no targets that are in relevant proximity, as depicted in the present figure and as shown on display 202.

It will be clear to those having ordinary skill in the art, after reading the present disclosure, how to make and use alternative embodiments wherein the bulk of the “proximity-control logic” and operations (see paragraph [0047] and method 500 below) are carried out by controller 250 such that mobile station 201 plays a more limited role. For example, in some alternative embodiments of the present invention, mobile station 201 and controller 250 operate based on a client-server architecture, wherein mobile station 201 gathers beacon signals from location-beacon devices 203 and transmits the gathered “raw data” to controller 250; in its turn, controller 250 executes many of the disclosed proximity-control logic operations of method 500 to generate an appropriate proximity list and/or list of icons and/or user interface, and further, to identify predefined commands to be executed based on a given change in the proximity list, which are then transmitted to mobile station 201; mobile station 201 receives the information from controller 250 and presents the user interface to the mobile user and/or executes an appropriate predefined action as a result of the change in the proximity list. It will be further clear to those having ordinary skill in the art, after reading the present disclosure, how to make and use alternative embodiments based on a client-server architecture as between mobile station 201 and controller 250, respectively; or based on another cooperative type of system architecture wherein mobile station 201 and controller 250 each carry out some, but not all, of the operations of method 500 (described in further detail below) or of alternative embodiments of method 500 according to the present invention.

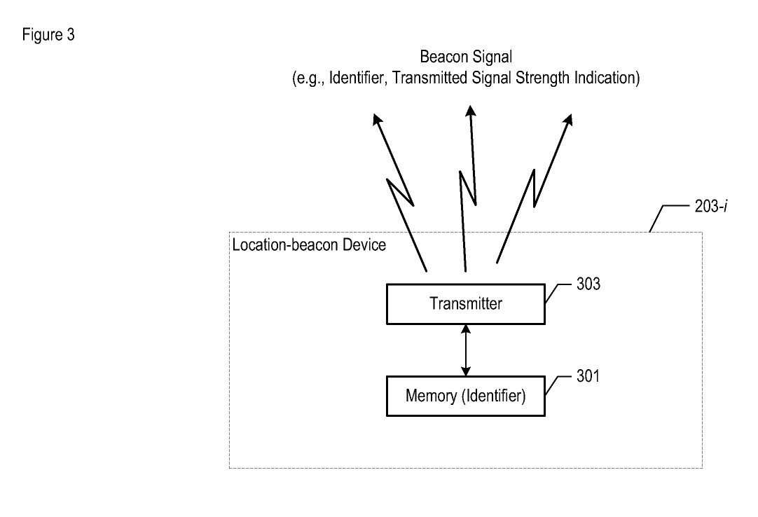

FIG. 3 depicts an illustrative hardware platform for a location-beacon device 203-i according to the illustrative embodiment. Location-beacon device 203-i comprises: memory 301, and transmitter 303. According to the illustrative embodiment, location-beacon device 203-i comprises active radio-frequency identification (“RFID”) technology and broadcasts a beacon signal.

Active RFID technology comprises a power source (not shown), and transmits using transmitter 303 a radio-frequency (“RF”) beacon signal via an integrated antenna (not shown). The location-beacon device 203-i also comprises a unique identifier stored in memory 301 that is transmitted in the beacon signal and that uniquely identifies the transmitting location-beacon device 203-i. The beacon signal also optionally comprises an indication of the signal strength of the beacon signal being transmitted (this information is used later in location estimation).

Active RFID technology and RFID constituent components are well known in the art. Although the illustrative embodiment uses active RFID as the technology platform for location-beacon device 203-i, the invention is not so limited. It will be clear to those having ordinary skill in the art, after reading the present disclosure, how to make and use alternative embodiments that use other RFID technology for location-beacon device 203-i, such as passive RFID technology, or a near-field communication (“NFC”) technology, or a combination thereof, without limitation. It will be further clear to those having ordinary skill in the art, after reading the present disclosure, how to make and use alternative embodiments that use other RF-based technology for location-beacon device 203-i, such as Bluetooth, or WiFi, etc., or a combination thereof, without limitation. As noted earlier, the present invention is not limited to only type of technology platform for the plurality of location-beacon devices 203.

Memory 301 is non-transitory and non-volatile computer storage memory technology that is well known in the art and that stores the unique identifier of location-beacon device 203-i.

Transmitter 303 is a component that enables location-beacon device 203-i to telecommunicate with other components and systems by transmitting signals thereto. For example, transmitter 303 transmits a beacon signal. Transmitter 303 is well known in the art. It will be clear to those having ordinary skill in the art how to make and use alternative embodiments that comprise more than one transmitter 303.

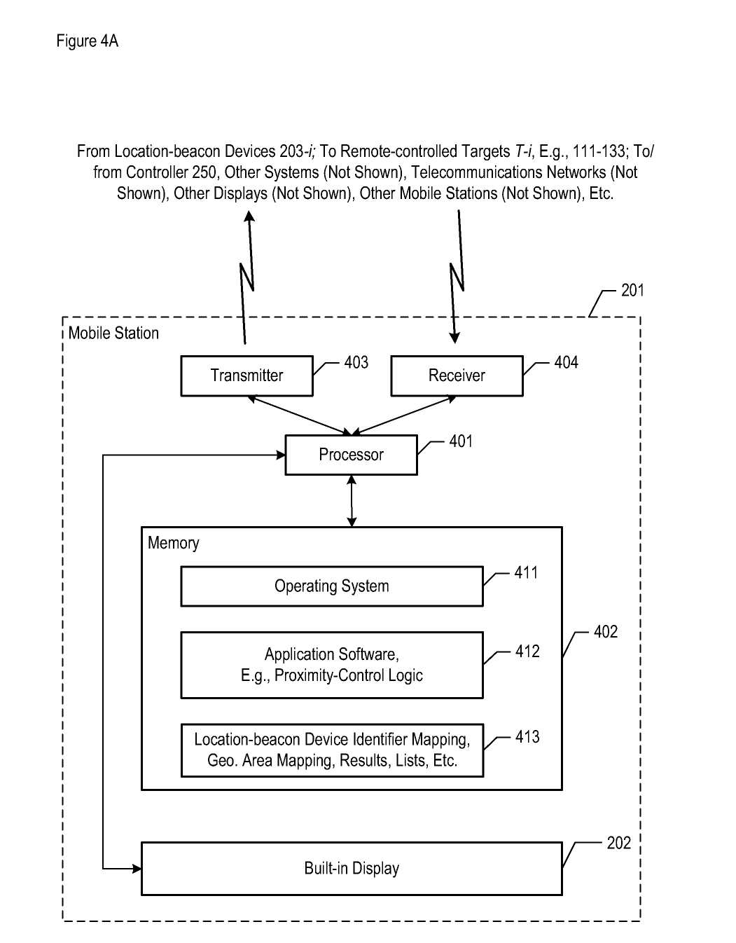

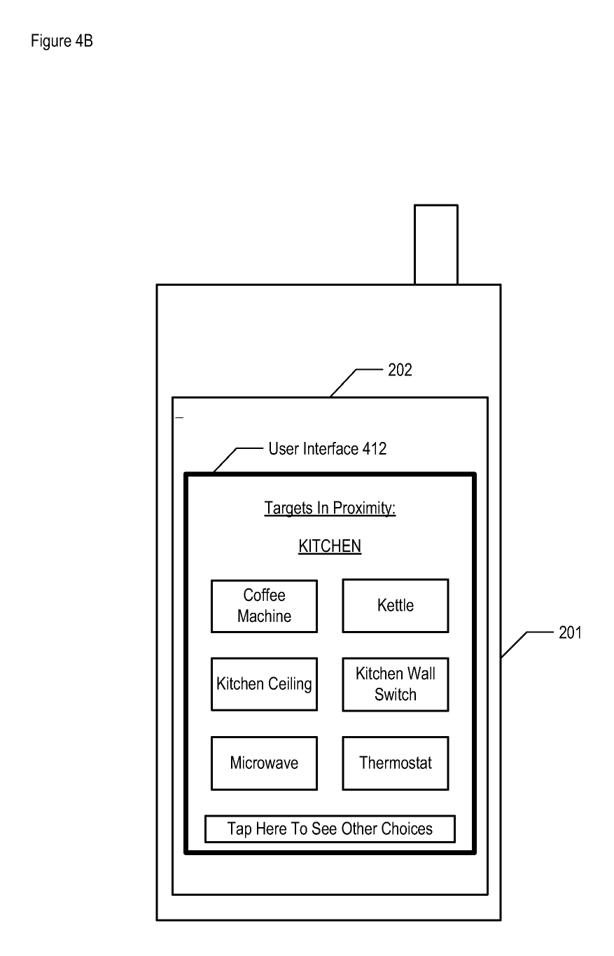

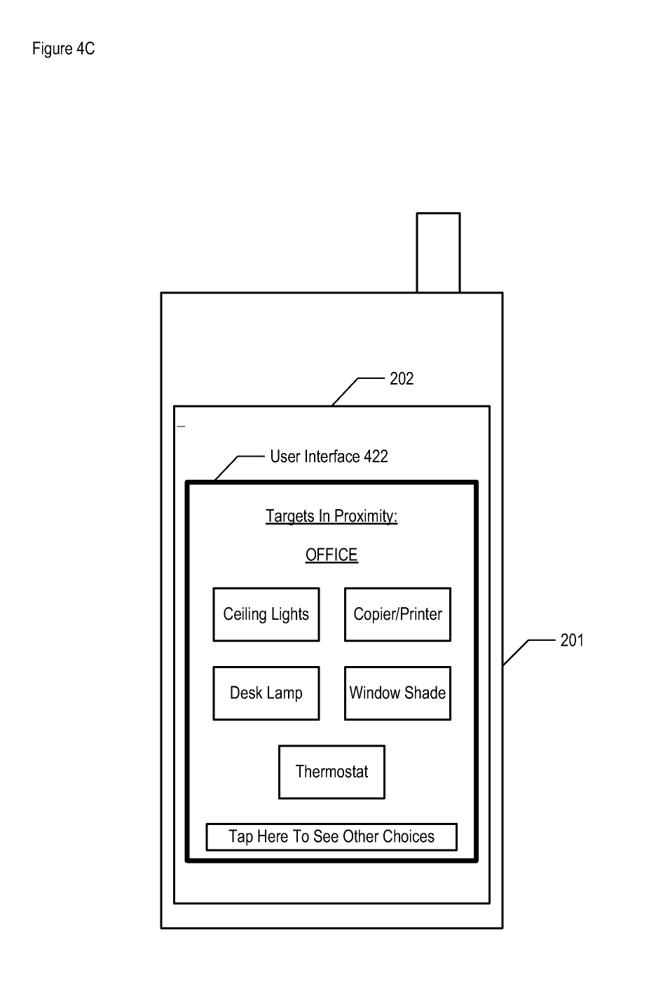

FIG. 4A depicts an illustrative hardware platform for a mobile station 201 according to the illustrative embodiment. Mobile station 201 comprises: built-in display 202, processor 401, memory 402, transmitter 403, and receiver 404. Mobile station 201 is an apparatus that comprises the hardware and software necessary to perform the methods and operations described below and in the accompanying figures in accordance with the illustrative embodiment. Mobile station 201 is mobile and telecommunicates wirelessly.

Mobile station 201 is illustratively a smartphone with voice/text and packet data services provided and supported by a wireless network (not shown). It will be clear to those having ordinary skill in the art, after reading the present disclosure, how to make and use alternative embodiments where mobile station 201 is a data-only tablet, or a wearable computer, or a smartwatch, or smartglasses (e.g., a Google Glasses platform), or a specialized remote-control unit, or any combination thereof, without limitation. For example and without limitation, mobile station 201 is capable of and configured to:
receive beacon signals from location-beacon device 203-i,
transmit signals to a remote-control receiver associated with a remote-controlled target T-i,
receive and transmit signals from/to controller 250, and
receive and transmit signals from/to one or more wireless networks (not shown).

Built-in display 202 is a component that enables mobile station 201 to present a user interface to a user according to the illustrative embodiment. Display 202 is well known in the art. Mobile station 201 comprises an interactive function associated with display 202 such that display 202 is a touch-screen that receives user input via touching or stroking the surface of display 202. However, it will be clear to those having ordinary skill in the art, after reading the present disclosure, how to make and use alternative embodiments wherein the interactivity with display 202 is accomplished in a different way, e.g., stylus, mouse, keyboard, etc. The functionality of the user interface and its presentation scheme is described in more detail below and in the accompanying figures.

Processor 401 is a processing device such as a microprocessor that is well known in the art. Processor 401 is configured such that, when operating in conjunction with the other components of mobile station 201, processor 401 executes software, processes data, and telecommunicates according to the operations described herein.

Memory 402 is non-transitory and non-volatile computer storage memory technology that is well known in the art, e.g., flash, etc. Memory 402 stores operating system 411, application software 412, and element 413 that comprises other data. The specialized application software 412 that is executed by processor 401 according to the illustrative embodiment is illustratively denominated the “proximity-control logic.” The proximity-control logic enables mobile station 201 to perform the operations of method 500. It should be noted that in some configurations where mobile station 201 collaborates with controller 250, controller 250 also comprises and executes some elements of the proximity control logic, for example, when controller 250 performs certain operations in response to data received from mobile station 201.

Memory element 413 illustratively comprises: mappings of location-beacon device to associated target, mappings to geographical areas, and other data, records, results, lists, associations, indicators, whether of an intermediate nature, final results, or archival. It will be clear to those having ordinary skill in the art how to make and use alternative embodiments that comprise more than one memory 402; or comprise subdivided segments of memory 402; or comprise a plurality of memory technologies that collectively store operating system 411, application software 412, and element 413.

Transmitter 403 is a component that enables mobile station 201 to telecommunicate with other components and systems by transmitting signals thereto. For example, transmitter 403 enables telecommunication pathways to controller 250, to remote-controlled targets T-i, to other systems (not shown), to wireless telecommunications network(s) (not shown), to external displays (not shown), to other mobile stations (not shown), etc., without limitation. Transmitter 403 is well known in the art. It will be clear to those having ordinary skill in the art how to make and use alternative embodiments that comprise more than one transmitter 403.

Receiver 404 is a component that enables mobile station 201 to telecommunicate with other components and systems by receiving signals therefrom. For example, receiver 404 enables telecommunication pathways from location-beacon devices 203-i, remote-controlled targets T-i, controller 250, other systems (not shown), wireless telecommunications network(s) (not shown), external displays (not shown), other mobile stations (not shown), etc., without limitation. Receiver 404 is well known in the art. It will be clear to those having ordinary skill in the art how to make and use alternative embodiments that comprise more than one receiver 404.

It will be clear to those skilled in the art, after reading the present disclosure, that in some alternative embodiments the hardware platform of mobile station 201 can be embodied as a multi-processor platform, as a sub-component of a larger computing platform, as a virtual computing element, or in some other computing environment—all within the scope of the present invention. It will be clear to those skilled in the art, after reading the present disclosure, how to make and use the hardware platform for mobile station 201.

FIG. 4B depicts an illustrative user interface 412 for mobile station 201 according to the illustrative embodiment. User interface 412 presents to the user the targets that are in relevant proximity of the current location of mobile station 201, illustratively six remote-controlled targets that are in the kitchen of the present building. User interface 412 is presented to the user via built-in display 202 on mobile station 201. Illustratively, user interface 412 depicts: a title block reciting “Targets In Proximity:”; a geographic-area descriptor block reciting “KITCHEN”; six icons identifying six different remote-controlled targets reciting “Coffee”, “Kettle”, “Kitchen Ceiling”, “Kitchen Wall Switch”, “Microwave” and “Thermostat”; and a continuation icon that recites “Tap Here to See Other Choices”—arrayed from the top to the bottom of the display.

User interface 412 is supported by the proximity-control logic being executed by mobile station 201. The targets presented in user interface 412 are based on the composition of the “proximity list” that is maintained by mobile station 201, and which is described in further detail below in regard to method 500 (see, e.g., paragraphs [0088]-[0092] below).

Illustratively, when the mobile user taps an icon of a target appearing in user interface 412, the proximity-control logic presents remote-control commands that are available to the user in regard to the respective target. Illustratively, when the mobile user taps the “Other Choices” icon, the proximity-control logic presents other available remote-controlled targets that are within remote-control range but which are not on the “proximity list.”

FIG. 4C depicts an illustrative user interface 422 for mobile station 201 according to the illustrative embodiment. User interface 422 presents to the user the targets that are in relevant proximity of the current location of mobile station 201, illustratively five remote-controlled targets that are in the office of the present building. User interface 422 is presented to the user via built-in display 202 on mobile station 201. Illustratively, user interface 422 depicts: a title block reciting “Targets In Proximity:”; a geographic-area descriptor block reciting “OFFICE”; five icons for five different identifiers of remote-controlled targets reciting “Ceiling Lights”, “Copier/Printer”, “Desk Lamp”, “Window Shade”, and “Thermostat”; and a continuation icon that recites “Tap Here to See Other Choices”—arrayed from the top to the bottom of the display.

User interface 422 is supported by the proximity-control logic being executed by mobile station 201. The targets presented in user interface 422 are based on the composition of the “proximity list” that is maintained by mobile station 201, and which is described in further detail below in regard to method 500 (see, e.g., paragraphs [0088]-[0092] below).

Illustratively, when the mobile user taps an icon of a target appearing in user interface 422, the proximity-control logic presents remote-control commands that are available to the user in regard to the respective target. Illustratively, when the mobile user taps the “Other Choices” icon, the proximity-control logic presents other available remote-controlled targets that are within remote-control range but which are not on the “proximity list.” It will be clear to those having ordinary skill in the art, after reading the present disclosure, how to make and use alternative embodiments wherein a default remote-control command is associated with the mobile user's tapping of a given icon so that when the mobile user taps the icon of a target appearing in user interface 422, the proximity-control logic automatically, without further user input, causes the default remote-control command to be executed as to that target. For example, when the mobile user taps the “Desk Lamp” icon on user interface 422, the proximity-control logic causes a remote-control command to issue that powers on the desk lamp, thus enabling one-touch remote control that is based on the proximity-control logic.

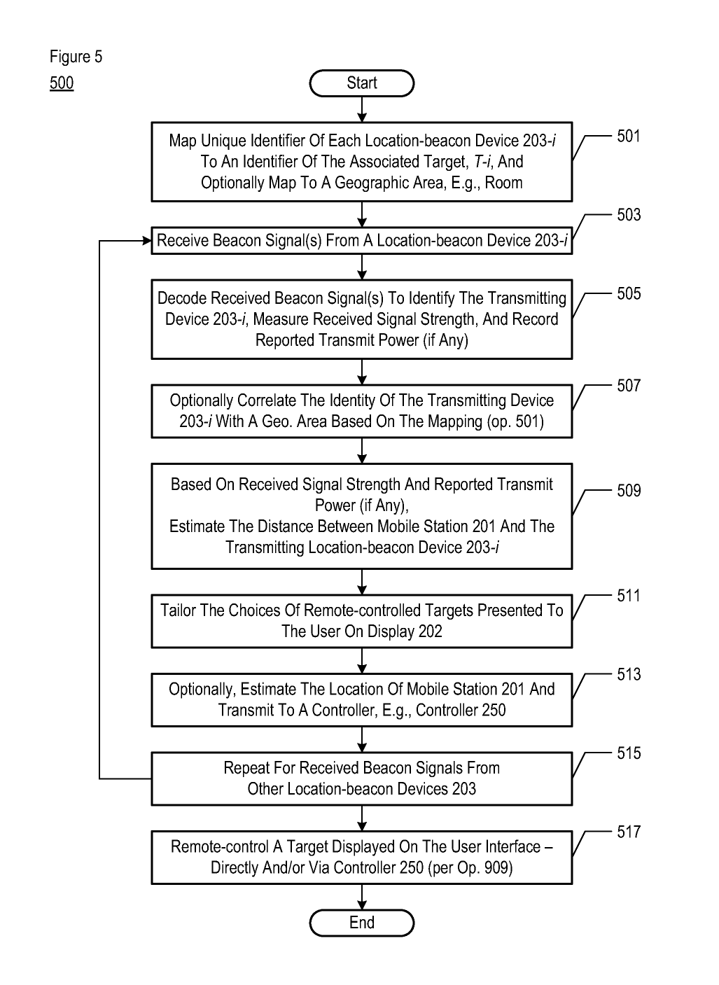

FIG. 5 depicts some salient operations of method 500 according to an illustrative embodiment of the present invention. According to the illustrative embodiment, mobile station 201 coordinates and performs the operations of method 500 based on executing the specialized application software referred to as the “proximity-control logic.”

At operation 501, mobile station 201 maps the unique identifier of each location-beacon device 203-i to an identifier of the associated remote-controlled target T-i. Optionally, mobile station 201 additionally maps the unique identifier of each location-beacon device 203-i and/or of each remote-controlled target T-i to a geographic area where each is installed. The geographic area is illustratively a room, and could also be a floor of a structure, another indicator (e.g., back door), etc., without limitation, depending on the layout of the building. The present mapping operation will be used later by the proximity-control logic to discriminate among different remote-controlled targets and also to present to the user the current geographic area occupied by mobile station 201. Operation 501 is described in further detail below and in the accompanying figures.

At operation 503, mobile station 201 receives one or more beacon signals from a location-beacon device 203-i.

At operation 505, mobile station 201 decodes the received beacon signal(s) to identify the transmitting location-beacon device. Mobile station 201 also measures and records the signal strength of the received beacon signal(s). When the received beacon signal(s) also comprises the transmit signal-strength thereof, mobile station 201 stores the transmit signal-strength information for subsequent use in the location estimation operation(s). Techniques for decoding a received beacon signal are well known in the art. Likewise, techniques for measuring a received signal strength and recording signal strength information are also well known in the art.

At operation 507 mobile station 201 correlates the identity of the transmitting location-beacon device 203-i with a geographic area, based on the mapping performed in operation 501. Operation 507 is optional. When the identity of the transmitting location-beacon device 203-i maps to a particular geographic area according to the mapping of operation 501, mobile station 201 stores the mapped-to geographic area for subsequent use as described in further detail below.

At operation 509, mobile station 201 estimates a distance between mobile station 201 and the transmitting location-beacon device 203-i, based on the received signal-strength and the reported transmit signal-strength (if any) (see operation 505). Techniques for estimating a distance between a receiver (mobile station 201) and a transmitter (location-beacon device 203-i) based on signal-strength measurements such as received signal-strength and/or transmitted signal-strength are well known in the art. Accordingly, mobile station 201 estimates a distance as between itself and the transmitting location-beacon device 203-i. The distance estimate optionally comprises a margin of error, without limitation.

It will be clear to those having ordinary skill in the art how to estimate the distance with and without an accompanying transmitted signal-strength indication as reported by the transmitting location-beacon device 203-i. It will be further clear to those having ordinary skill in the art, after reading the present disclosure, how many beacon signals from location-beacon device 203-i are to be received and decoded by mobile station 201 in order to estimate the distance to the transmitting location-beacon device 203-i with a desired level of accuracy. It will be further clear to those having ordinary skill in the art, after reading the present disclosure, how to make and build alternative embodiments that estimate the distance when some beacons signals comprise a transmitted signal-strength indication and other beacons signals do not. It will be further clear to those having ordinary skill in the art, after reading the present disclosure, how to make and build alternative embodiments that estimate the distance with respect to location-beacon devices that have a variety of different underlying technologies, i.e., wherein the proximity-control logic applies different techniques for estimating the distance depending on the type of location-beacon device that transmitted the beacon signal.

At operation 511, mobile station 201 tailors the choice of remote-controlled targets that are presented to the user of mobile station 201 on display 202. This operation is described in more detail below and in the accompanying figures.

At operation 513, mobile station 201 estimates a location of mobile station 201 and transmits the location and other relevant information to a controller, illustratively to controller 250. Operation 513 is optional. Operation 513 is described in more detail below and in the accompanying figures.

At operation 515 mobile station 201 passes control to operation 503 to analyze received beacon signal(s) from other location-beacon devices, which is a continuous cycle necessary to stay abreast of movement by mobile station 201. Additionally, mobile station 201 passes control to operation 517 when remote-controlling a target is appropriate.

At operation 517, mobile station 201 remote-controls a remote-controlled target that is displayed on the user interface presented to the user on display 202; the remote-control operation is performed directly from mobile station 201 and/or via controller 250 (as enabled and described in further detail in operation 909). Thus, based on the tailored choices presented to the user of mobile station 201 in operation 511, the mobile user chooses a remote-controlled target and activates a remote-control command illustratively via mobile station 201; consequently, mobile station 201 transmits a signal comprising the remote-control command directly to the selected target; optionally, mobile station 201 transmits a signal comprising the remote-control command to controller 250, which receives the signal, decodes it, and transmits a signal to the selected target to perform the remote-control command activated by the user of mobile station 201. Furthermore, as described in more detail in the scenario of operation 715 below, a predefined action that does not require any input from the mobile user can be automatically triggered based on a change in the proximity list, such that a remote-control command is issued (whether by mobile station 201 or controller 250) to a given remote-controlled target according to whether the change in the proximity list has added or dropped the target from the proximity list.

In some alternative embodiments, controller 250 further comprises its own additional logic and features that are driven by signals received from mobile station 201, but which are not necessarily expressly activated by the user of mobile station 201. For example, when mobile station 201 estimates the location of mobile station 201 and reports its current estimated location (or the associated geographic area) to controller 250 (see e.g., operation 513), controller 250 powers on (via respective remote-control commands) one or more light-fixture targets in the geographic area where mobile station 201 is estimated to be currently located. Thus, mobile station 201 and controller 250 have a collaborative relationship wherein data reported by mobile station 201 is interpreted and used by controller 250 to perform operations that are not expressly selected by the user of mobile station 201, but which are based on what is happening with mobile station 201. Method 500 ends with operation 517.

In regard to method 500, it will be clear to those having ordinary skill in the art, after reading the present disclosure, how to make and use alternative embodiments of method 500 wherein the recited operations and sub-operations are differently sequenced, grouped, or sub-divided—all within the scope of the present invention. It will be further clear to those skilled in the art, after reading the present disclosure, how to make and use alternative embodiments of method 500 wherein some of the recited operations and sub-operations are optional, are omitted, or are executed by other elements and/or systems, e.g., controller 250. It will be further clear to those skilled in the art, after reading the present disclosure, how to make and use alternative embodiments of method 500 wherein mobile station 201 supports and operates with any number of remote-controlled targets T-i, any number of location-beacon devices 203-i, and any number of controllers 250 while executing one or more versions of method 500.

It will be clear to those having ordinary skill in the art, after reading the present disclosure, how to make and use alternative embodiments wherein the bulk of the proximity-control logic and operations are carried out by controller 250 such that mobile station 201 plays a more limited role. For example, in some alternative embodiments of the present invention, mobile station 201 and controller 250 operate based on a client-server architecture, wherein mobile station 201 gathers beacon signals from location-beacon devices 203 and transmits the gathered “raw data” to controller 250; in its turn, controller 250 executes many of the disclosed proximity-control logic operations of method 500 to generate an appropriate proximity list and/or list of icons and/or user interface, which are then transmitted to mobile station 201; mobile station 201 receives the information from controller 250 and, as appropriate, generates and presents the user interface to the mobile user. It will be further clear to those having ordinary skill in the art, after reading the present disclosure, how to make and use alternative embodiments of method 500 based on a client-server architecture as between mobile station 201 and controller 250, respectively; or based on another cooperative type of system architecture wherein mobile station 201 and controller 250 each carry out some, but not all, of the operations of method 500 or of alternative embodiments of method 500 according to the present invention. Accordingly, it is to be understood that one or more of the operations and sub-operations of method 500 can be executed by controller 250, by mobile station 201, by either one, or by both, in any combination according to the design choices made by the implementers practicing the present invention.

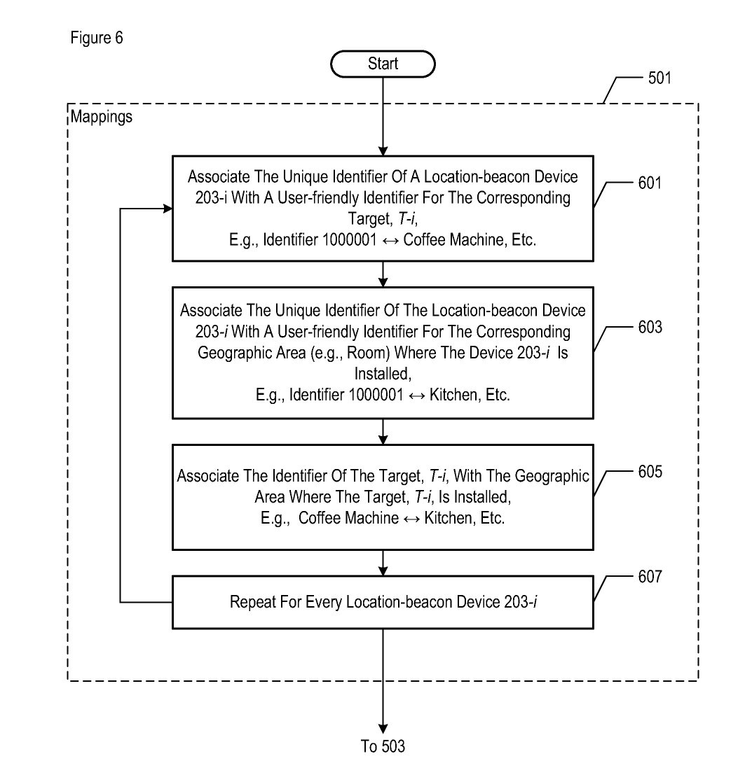

FIG. 6 depicts some salient sub-operations of operation 501 according to the illustrative embodiment.

At operation 601, mobile station 201 associates the unique identifier of a location-beacon device 203-i with a user-friendly identifier for the corresponding target T-i. In this way, mobile station 201 generates an association as between a location-beacon device and the remote-controlled target that it is affixed to or proximate to, as the case may be. Illustratively, identifier 1000001 for location-beacon device 203-121 is associated with the user-friendly identifier “Coffee Machine” representing remote-controlled target appliance 121. The present operation thus generates a mapping of location-beacon device identifiers to target identifiers.

At operation 603, mobile station 201 associates the unique identifier of the location-beacon device 203-i with a user-friendly identifier for the corresponding geographic area where the location-beacon device is installed. In this way, mobile station 201 generates an association between a location-beacon device and a geographic area. Illustratively, identifier 1000001 for location-beacon device 203-121 is associated with the user-friendly identifier “Kitchen” representing room 2. The present operation thus generates a mapping of location-beacon device identifiers to geographic areas.

At operation 605, mobile station 201 associates the user-friendly identifier of the remote-controlled target T-i with the user-friendly identifier for the corresponding geographic area where the target is installed. In this way, mobile station 201 generates an association between a target and a geographic area. Illustratively, user-friendly identifier “Coffee Machine” representing remote-controlled target appliance 121 is associated with the user-friendly identifier “Kitchen” representing room 2. The present operation thus generates a mapping of target identifiers to geographic areas.

At operation 607, mobile station 201 passes control back to operation 601 to repeat the mappings for every location-beacon device 203-i in and/or supported by dynamic proximity control system 200.

It will be clear to those having ordinary skill in the art, after reading the present disclosure, how to make and use alternative embodiments that perform different mappings or use different monikers or perform additional or nested mappings as appropriate to the configuration and geography of the dynamic proximity control system being implemented.

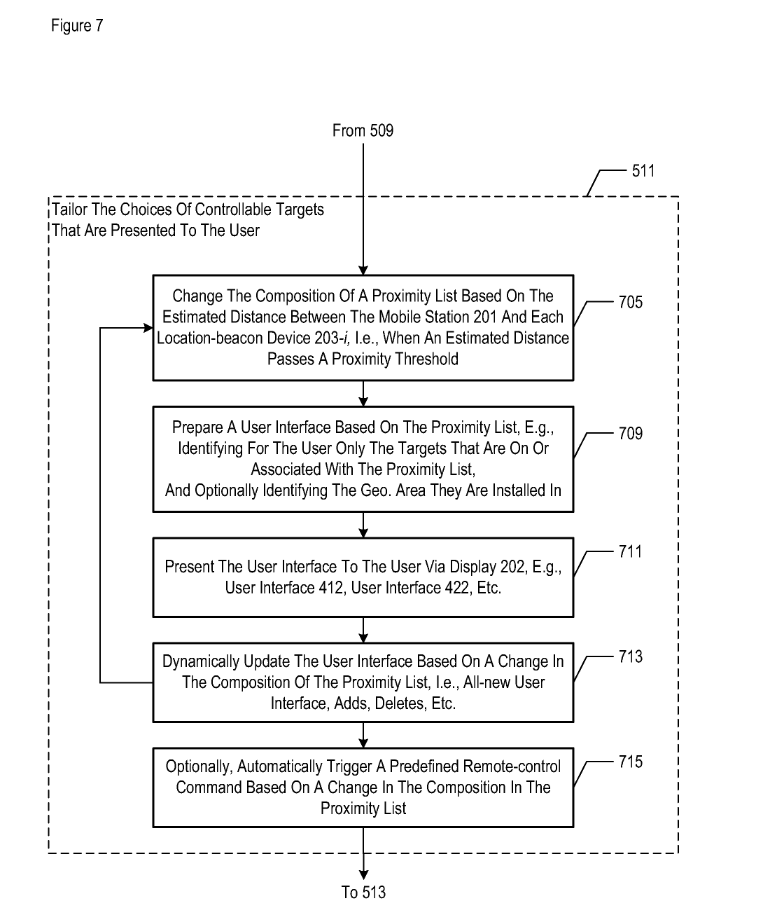

FIG. 7 depicts some salient sub-operations of operation 511 according to the illustrative embodiment.

At operation 705, mobile station 201 operates upon the “proximity list” based on the estimated distance (obtained in operation 509) between mobile station 201 and each location-beacon device 203. Mobile station 201 changes the composition of the proximity list when an estimated distance between mobile station 201 and location-beacon device 203-i passes a proximity threshold. The proximity threshold is said to be passed when a distance that previously exceeded the threshold is currently estimated to be within the threshold; the proximity threshold is also said to be passed when a distance that previously was within the threshold is currently estimated to exceed the threshold. Operation 705 is described in further detail below and in the accompanying figures.

At operation 709, mobile station 201 prepares a user interface based on the composition of the proximity list, i.e., based on the elements that the proximity list comprises. Thus, for example, the user interface that is prepared in the present operation identifies for the user only the remote-controlled targets that are a constituent element of the proximity list or that are associated with a constituent element of the proximity list. Optionally, mobile station 201 additionally identifies the geographic area where each constituent element of the proximity list is installed. Thus, for example, if the proximity list comprises identifiers for (or associated with) appliance 121 and wall-switch 122, in the present operation mobile station 201 prepares a user interface that identifies appliance 121, wall-switch 122, and their associated geographic area, namely room 2. Preferably, the user interface comprises user-friendly identifiers that would be useful to the user of mobile station 201, such as “coffee machine” for the target and “kitchen” for the geographic area.

It will be left to the implementers who practice the present invention to devise a desirable and appropriate format for the user interface being prepared in the present operation, such as size, resolution, color, icons, labels, etc.

At operation 711, mobile station 201 presents the user interface prepared in the preceding operation to the user of mobile station 201 via display 202. Illustrative examples of a user interface being displayed on display 202 can be found in FIGS. 4B and 4C, depicting user interface 412 and user interface 422, respectively.

At operation 713, mobile station 201 determines that a change occurred in the composition of the proximity list and, based on the change in the composition, dynamically updates the user interface presented to the user. Illustratively, as mobile station 201 moves from the kitchen to the office, the distances between mobile station 201 and the various targets in the kitchen become larger, exceeding the proximity threshold and slipping off the proximity list, while the distances between mobile station 201 and the various targets in the office become smaller and fall within the proximity threshold. As a result, the composition of the proximity list changes, and based on this change, mobile station 201 updates the user interface being presented to the user, dynamically, without requiring an express update request from the user. Illustratively mobile station 201 dynamically updates the user interface from 412 to 422. As the user moves while carrying mobile station 201, the display presents a tailored set of target choices that are appropriate to the user's current location and relative distance to the various targets supported by dynamic proximity control system 200. This might include an all-new user interface, such as updating from user interface 412 to user interface 422, or adds and deletes of individual targets from an existing user interface. Mobile station 201 passes control back to operation 705 to cycle through the analysis in respect to further changes in the composition of the proximity list. Mobile station 201 also passes control to operation 513 for other operations, as described in more detail below and in the accompanying figures.

At operation 715, one or more predefined actions are triggered based on a change in the composition of the proximity list, such that regardless of what information is dynamically presented on the display of mobile station 201, the predefined actions occur absent any express interaction with the mobile user. A predefined action that does not require any input from the mobile user can be automatically triggered based on a change in the composition of the proximity list, such that a remote-control command is issued (whether by mobile station 201 or controller 250) to a given remote-controlled target according to whether the change in the proximity list has added or dropped the target from the proximity list. Accordingly, a number of variations and scenarios are contemplated within the scope of the present invention, based in part on the architecture and feature capabilities of controller 250 and/or mobile station 201, and further based on variations of method 500. For example, one illustrative scenario comprises:
A mobile user enters a room carrying mobile station 201 in a pocket;
The portion of the proximity-control logic that receives beacon signals runs in the background on mobile station 201 and detects a beacon signal associated with an appliance within the proximity threshold, illustratively a light bulb in the room;
A predefined action associated with the appliance is automatically triggered once the mobile station and the appliance are within the proximity threshold (as determined by mobile station 201 or, alternatively, as determined by controller 250), i.e., the predefined action is based on a change in the proximity list;
The predefined action is invoked (by mobile station 201 or, alternatively, by controller 250) in reference to the target, illustratively issuing a remote-control power-on command directed to the illustrative light bulb—consequently, the light bulb powers on;
When the mobile user, still carrying mobile station 201 in the pocket, leaves the room, the proximity-control logic continues to execute and detect beacons signals from the target, and ultimately determines that the target is no longer within the proximity threshold of mobile station 201;
Another (second) predefined action is triggered once it is determined (by mobile station 201 or, alternatively, as determined by controller 250) that the target and mobile station are no longer within the proximity threshold, i.e., this second predefined action is based on a change in the proximity list;
The second predefined action is invoked (by mobile station 201 or, alternatively, by controller 250) in reference to the target, illustratively issuing a remote-control power-off command directed to the illustrative light bulb—consequently, the light bulb powers off.
   Notably, the mobile user has not taken any express actions in respect to the remote-controlled target, i.e., the illustrative light bulb. Rather the actions were predefined in the dynamic proximity control system 200 and were automatically triggered, initiated, and executed based on changes in the composition of the proximity list as mobile station 201 moved around.

As noted, operation 511 tailors the choices of controllable remote-controlled targets that are presented to the user of mobile station 201—based at least in part on the current constituent elements of the proximity list. Additionally, operation 511 also automatically triggers remote-control commands based on changes in the composition of the proximity list. Operation 511 is performed continuously and iteratively by mobile station 201 as described herein, thus resulting in near-real-time dynamic updating of the user interface and/or triggering of predefined remote-control commands without express update requests or interaction from the user. It will be clear to those having ordinary skill in the art, after reading the present disclosure, how to design and implement operation 511 so that it is appropriately timed and coordinated with the location estimation operations so that the user experience in regard to mobile station 201 is such that the displayed user interface is automatically and dynamically updated in near-real-time. It will be further clear to those having ordinary skill in the art, after reading the present disclosure, how to make and use alternative embodiments wherein the updating is performed in response to an express command/demand from the user of mobile station 201; or in response to a command received by mobile station 201 from controller 250.

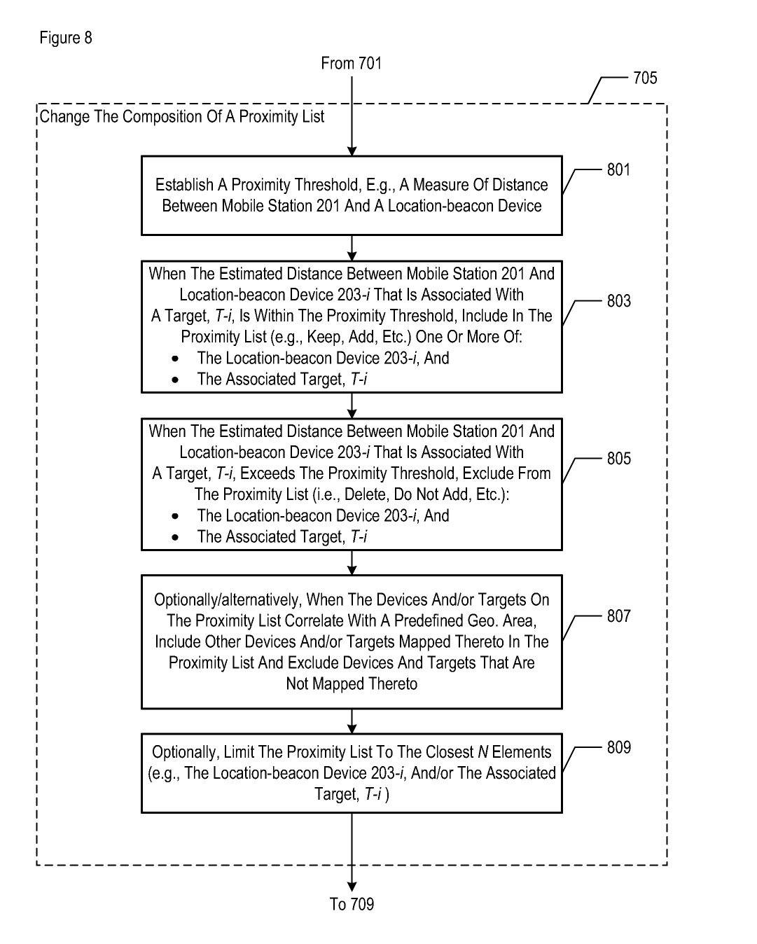

FIG. 8 depicts some salient sub-operations of operation 705 according to the illustrative embodiment.

At operation 801, mobile station 201 establishes a proximity threshold. Illustratively, the “proximity threshold” is a measure of distance as between the mobile station 201 and a location-beacon device 203, but the invention is not so limited. Illustratively, the proximity threshold is a fixed distance of 2 (two) meters, but it will be clear to those having ordinary skill in the art, after reading the present disclosure, how to make and use alternative embodiments wherein the proximity threshold has a different value, or is a different measure, or is a range of distance, or wherein the system employs more than one proximity threshold, or any combination thereof.

At operation 803, mobile station 201 operates on the proximity list: when the estimated distance between mobile station 201 and location-beacon device 203-i that is associated with a remote-controlled target T-i is within the proximity threshold (i.e., less distant than the proximity threshold), mobile station 201 includes in the proximity list one or more of the following elements:
the identity of the location-beacon device 203-i, and
the identity of the associated target T-i, and
the estimated distance between the mobile station 201 and the location-beacon device 203-i.
   Illustratively, the proximity list comprises both the identity of the location-beacon device 203-i and the identity of the associated target T-i, organized such that each element is a tuple, e.g., (identifier of location-beacon device 203-i, identifier of associated target T-i, estimated distance between location-beacon device 203-i and mobile station 201). It will be clear to those having ordinary skill in the art, after reading the present disclosure, how to make and use alternative embodiments wherein the proximity list comprises only location-beacon device 203-i identifiers, or only target identifiers. When a tuple element is not already on the proximity list, mobile station 201 adds it to the proximity list, thus creating a change in the composition of the proximity list. When the tuple element is already on the proximity list, the tuple element remains on the proximity list, thus not changing the composition of the proximity list.

At operation 805, mobile station 201 operates on the proximity list: when the estimated distance between mobile station 201 and location-beacon device 203-i that is associated with a remote-controlled target T-i exceeds (i.e., is more distant than) the proximity threshold, mobile station 201 excludes from the proximity list the tuple element comprising:
the identity of the location-beacon device 203-i, and
the identity of the associated target T-i.
   When the aforementioned tuple element is already on the proximity list, mobile station 201 removes the tuple element from the proximity list, thus creating a change in the composition of the proximity list. When the aforementioned tuple element is not already on the proximity list, the composition of the proximity list remains unchanged.

At operation 807, which is optional in the illustrative embodiment, when the location-beacon devices and/or targets on the proximity list correlate with a single predefined geographic area, mobile station 201 operates further upon the proximity list by:
including in the proximity list other tuples comprising location-beacon devices and/or associated targets that are mapped to the single predefined geographic area, e.g., room, floor, etc., and
excluding from the proximity list other tuples comprising location-beacon devices and/or associated targets that are mapped to a geographic area that is different from the correlated geographic area.

Illustratively, when the majority of elements on the proximity list map to a single geographic area (according to the mapping in operation 501), the single geographic area is said to correlate, in effect suggesting that mobile station 201 is most likely currently occupying the correlated geographic area. Based on the correlation, mobile station 201 includes all the elements mapped to the single geographic area into the proximity list and further, mobile station 201 excludes any elements that do no map to the single correlated geographic area. As a result of the aforementioned including and excluding operations, further changes to the proximity list could result, such as by adding other elements from the correlating geographic area or removing elements that are mapped to other geographic areas, even if they made it onto the proximity list in one of the preceding operations based on the proximity threshold.

In some alternative embodiments, the present operation 807 always follows operations 803 and 805 such that the “final” proximity list is always limited to the elements in a single correlated geographic area, e.g., the room that mobile station 201 currently occupies. It will be clear to those having ordinary skill in the art, after reading the present disclosure, how to make and use alternative embodiments wherein the correlation between elements on the proximity and a predefined geographic area is defined and determined differently, or wherein the operations upon the proximity list as a result of a correlation are different than the illustrative embodiment.

At operation 809, mobile station 201 optionally limits the proximity list to a fixed number of elements, N, representing the elements that mobile station 201 has estimated to be the closest to mobile station 201. The purpose of this feature is, in keeping with the objective of predicting and simplifying the user's choices, to present to the user only a relatively small and practical number of choices. For example, if the user is in a geographic area that has dozens of remote-controlled targets, e.g., a factory floor, it would be practical to present to the user only the 5 closest targets, even if two dozen targets are present and accessible on the factory floor. The size of display 202 and of the user interface that can be displayed on it also are factors in establishing the figure N, which will be left to the implementers.

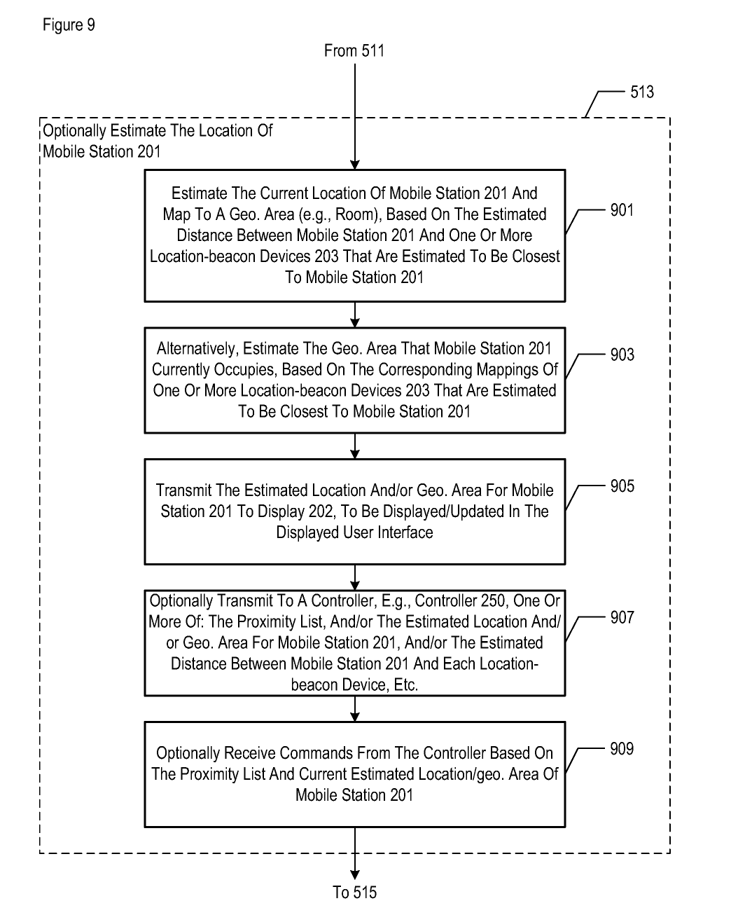

FIG. 9 depicts some salient sub-operations of operation 513 according to the illustrative embodiment.

At operation 901, mobile station 201 estimates the current location of mobile station 201 and maps it to a geographic area; the estimated location of mobile station 201 is based on the estimated distance between mobile station 201 and one or more location-beacon devices 203 that are estimated to be closest to mobile station 201. The location can be a one-dimensional, two-dimensional, or three-dimensional descriptor, such as a geo-location. Accordingly, mobile station 201 determines where mobile station 201 is located relative to the known locations of three neighboring location-beacon devices using, illustratively, triangulation; or alternatively, using trilateration and/or other techniques that are well known in the art and that implementers regard as providing a current location estimate of sufficient accuracy for the purposes of the present invention.

At operation 903, in an alternative to operation 901, mobile station 201 estimates the geographic area that mobile station 201 currently occupies based on the corresponding mappings of one or more location-beacon devices that are estimated to be closest to mobile station 201. Accordingly, mobile station 201 determines where mobile station 201 is located relative to the known geographic area of (illustratively) two closest location-beacon devices, but it will be clear to those having ordinary skill in the art, after reading the present disclosure, how to make and use alternative embodiments wherein the geographic area currently occupied by mobile station 201 is determined in a different way or based on more data, or using other estimation techniques.

At operation 905, mobile station 201 transmits the estimated location (from operation 901) and/or the estimated geographic area (from operation 903) to display 202 to be displayed and updated with the user interface. This information is dynamically updated based on proximity changes in a manner analogous to operation 713. Thus, as mobile station 201 moves from one geographic area to another, and changes in the proximity list occur, likewise, the user interface would dynamically update the geographic area identifier as appropriate.

At operation 907, mobile station 201 optionally transmits to controller 250 one or more of:
the current proximity list,
the estimated current location of mobile station 201,
the estimated current geographic area occupied by mobile station 201,
the estimated distance between mobile station 201 and each location-beacon device 203 in system 200, and
any combination thereof.
   According to the illustrative embodiment, the transmission occurs wirelessly, via one or more RF signals.

At operation 909, mobile station 201 optionally receives signals from controller 250, the signals comprising commands issued by controller 250. Illustratively, a command from controller 250 that is directed at a particular target T-i is based on the proximity list and on the current estimated location and/or geographic area of mobile station 201, and instructs mobile station 201 to transmit the instructed command to the particular target T-i. For example, controller 250 instructs mobile station 201 to transmit a particular remote-control command to each target in the geographic area that mobile station 201 is currently estimated to occupy, e.g., to every target in the office; for example, controller 250 instructs mobile station 201 to transmit a power-on remote-control command to a ceiling light fixture that is identified on the proximity list; for example, controller 250 instructs mobile station 201 to transmit a power-off remote-control command to a night-light that is identified on the proximity list; for example, controller 250 instructs mobile station 201 to transmit a power-on remote control command to an appliance identified on the proximity list that is within a 0.25-meter estimated distance of mobile station 201, e.g., activate the coffee machine when mobile station 201 is within 0.25-meter of the coffee machine, etc. without limitation.

It is to be understood that the disclosure herein teaches just one example of the illustrative embodiment and that many variations of the present invention can be devised by those skilled in the art after reading the present disclosure. The scope of the present invention is to be determined by the following claims.

1-20. (canceled)

21. A method that is associated with a system, the system comprising a mobile station, a plurality of location-beacon devices, a plurality of remote-controlled targets, and a central controller, the method comprising:
receiving, at the mobile station, a beacon signal from each of the location-beacon devices, wherein each location-beacon device is associated with a respective one of the remote-controlled targets;
receiving, at the central controller, first information from the mobile station, the first information comprising a location of the mobile station;
estimating, by the system, a distance between the mobile station and each location-beacon device based on second information pertaining to each beacon signal received at the mobile station;
generating commands at the central controller based on the first and second information, wherein the commands pertain to one or more actions to be taken by at least one of the remote-controlled targets; and
transmitting the commands from the central controller to at least one of:
(i) the mobile station, wherein the commands transmitted to the mobile station cause the mobile station to remotely control the at least one remote-controlled target to take the one or more actions; and
(ii) the at least one remote-controlled target to cause same to take the one or more actions.

22. The method of claim 21 and further wherein the estimate of distances is performed by the central controller.

23. The method of claim 21 wherein the mobile station and the central controller communicate with one another via a direct wireless connection.

24. The method of claim 21 and further comprising:
generating, by the system, a proximity list based on the estimate of distances, wherein:
(i) when the estimated distance between the mobile station and the location-beacon device that is associated with a second remote-controlled target is within a proximity threshold, the second remote-controlled target is included in the proximity list, and
(ii) when the estimated distance between the mobile station and the location-beacon device that is associated with the second remote-controlled target exceeds the proximity threshold, the second remote-controlled target is excluded from the proximity list generated; and
dynamically updating, based on a change in the composition of the proximity list, a displayed user interface at the mobile station that comprises the identity of a first remote-controlled target that is associated with the changed composition of the proximity list.

25. The method of claim 24 and further wherein the proximity list is generated by the central controller.

26. The method of claim 24 and further wherein the dynamic updating is performed by the central controller.

27. The method of claim 24 wherein the proximity list comprises at least one of:
(i) the identity of each location-beacon device whose estimated distance is within the proximity threshold, and
(ii) for each location-beacon device whose estimated distance is within the proximity threshold, the identity of the respective associated remote-controlled target.

28. The method of claim 24 further comprising remotely controlling the first remote-controlled target, based on the change in the composition of the proximity list.

29. The method of claim 24 wherein the proximity list comprises the identity of each remote-controlled target that is located in at least one of: (1) the same geographic area as the first remote-controlled target and (2) the same geographic area as the mobile station.

30. The method of claim 21 wherein the estimating of the distance between the mobile station and a first location-beacon device is based at least in part on a signal-strength at the mobile station of a first beacon signal received from the first location-beacon device.

31. The method of claim 21 wherein the estimating of the distance between the mobile station and a first location-beacon device is based at least in part on (i) a first signal-strength at the mobile station of a first beacon signal received from the first location-beacon device, and (ii) a second signal-strength as transmitted by the first location-beacon device in the first beacon signal.

32. The method of claim 21 and further comprising receiving, at the central controller, a command from the mobile station that is intended for a first remote-control target.

33. The method of claim 32 and further comprising transmitting, to the first remote-control target, a signal that causes the first remote-control target to carry out the command.

34. A system comprising:
a plurality of location-beacon devices, wherein each location-beacon device is associated with a respective remote-controlled target;
a mobile station that receives a beacon signal from each of the plurality of location-beacon devices;
a central controller, wherein the central controller:
(i) receives, from the mobile station, first information pertaining to a location of the mobile station;
(ii) generates commands pertaining to at least one action to be taken by at least one of the remote-controlled targets;
(iii) transmits the commands to at least one of:
(a) the at least one remote-controlled target;
(b) the mobile station;
and wherein at least one of the mobile station and the central controller:
(i) generate a proximity list that is based on an estimated distance between the mobile station and each location-beacon device, wherein the estimated distance is based on the beacon signal received, and wherein when the estimated distance between the mobile station and the location-beacon device that is associated with a second remote-controlled target:
(a) is within a proximity threshold, the second remote-controlled target is included in the proximity list generated, and
(b) exceeds the proximity threshold, the second remote-controlled target is excluded from the proximity list generated, and
(ii) perform, based on a change in the composition of the proximity list, at least one of:
(a) dynamically updating a displayed user interface that comprises the identity of a first remote-controlled target that is associated with the changed composition of the proximity list, and
(b) remotely controlling the first remote-controlled target.

35. The system of claim 34 wherein, for each location-beacon device within a proximity threshold, the displayed user interface comprises the identity of the respective associated remote-controlled target.

36. The system of claim 34 wherein the mobile station is further configured to remotely control, according to a predefined remote-control command, the first remote-controlled target based on the change in the composition of the proximity list.

37. The system of claim 34 wherein the mobile station and the central controller communicate with one another via a direct wireless connection.

38. The system of claim 34 and further wherein:
(i) the central controller receives second information pertaining to each beacon signal received at the mobile station; and
(ii) the central controller generates the proximity list.

39. The system of claim 34 and further wherein the central controller receives, from the mobile station, a command intended for a first remote-control target and transmits a signal to the first remote-control target that causes same to carry out the command.

40. The method of claim 34 wherein the displayed user interface is generated by the central controller.
